(19) United States
(12) Patent Application Publication
(10) Pub. No.: US 2002/0158854 A1
(43) Pub. Date: Oct. 31, 2002

(54) Stylus pen for personal digital mobile device

(76) Inventor: Ted Ju, Keelung City (TW)

Correspondence Address: BACON & THOMAS, PLLC, 4th Floor, 625 Slaters Lane, Alexandria, VA, 22314-1176, US

(21) Appl. No.: 09/843,804

(22) Filed: Apr. 30, 2001

(51) Int. Cl. G09G 5/00

(52) U.S. Cl. 345/179

(57) ABSTRACT

A personal digital mobile device stylus pen having its nib adjustable for its angle to buffer excessive force used to contact a touch monitor from a PDA or related product so to protect the touch monitor and to offer a touch angle that is most comfortable to its user as the stylus pen either bends or rotates when being subject to excessive force upon contacting the touch monitor characterized by a hollow nib cap is screwed in position at the end of the penholder to secure the nib having a ball at its rear end. Said nib cap contains a pad and a touch needle is screwed to the rear end of the nib cap to press the ball of the nib by the touch needle so that the nib only bends or rotates when being subject to a certain pressure to adjust its touching angle depending on the personal habit of holding a pen and to protect a PDA touch monitor from being damaged by excessive contact force from the nib which bends to offset such excessive force.

### BACKGROUND OF THE INVENTION

(a) Field of the Invention

The present invention relates to a stylus pen for personal digital mobile device, and more particularly, to one that with touching angle changeable as desired when applied onto an electronic product such as a Personal Digital Assistant (PDA) or any PDA-related touch monitor to select options. The present invention offers a better control of said product at any angle and to protect the touch monitor by bending the pen nib in case of excessive point pressure applied to the touch monitor.

(b) Description of the Prior Art:

When first introduced into the market, the PDA relates to a simplified electronic notebook functioning similarly to that generally used by the 9-5 for control of information of events, figures, letters, addresses, phone numbers, and other things and matters that required to be completed or taken note. It provides a pocket information for people to work in a more efficient way. At present, the PDA(Personal Digital Assistant), after years of development and incorporation with computer science has become a mobile device that allows people to communicate, link and interact on network. The PDA for outperforming a Notebook in terms of size, weight or power-saving effect has become the mainstream product in the age of information.

A PDA of a personal digital mobile device 100 as illustrated in FIG. 1 of the accompanying drawings of the present invention is characterized by its compact structure with a keyboard as adapted to a notebook is omitted. Instead, a touch monitor 101 is used for data input and window selection. The size of the touch monitor 101 prevents the selection by a fingertip of a user. Therefore, a PDA generally available in the market is adapted with a stylus pen to control the operation and select options on the touch monitor 110. However, an ordinary monitor or a touch monitor 101 is not made to withstand excessive pressure from the stylus pen. If excessive force is applied at the pen nib, electronic device in said monitor will be damaged leaving dark traces on the monitor.

The stylus pen of the prior art is for the user to apply pressure on the holder of the pen to create more pressure downward from the pen nib by taking advantage of the force of arm created from the penholder. If excessive force is exercised at the pen nib, the monitor 101 can be easily damaged. Furthermore, the pen nib contacts the touch monitor 101 by point making it more vulnerable to be damaged. In addition, the user tends to hold the pen at a certain inclination. Such a motion of holding the pen as the user gets used to is not necessarily compromising movement of his/her arm while holding the pen to touch the monitor 110. For those reasons given above, there is a desperate need to develop a stylus pen for the PDA or PDA-related electronic product that helps relieve pressure upon the hand of the use and allows change the angle of the nib as desired.

### SUMMARY OF THE INVENTION

The primary purpose of the present invention is to provide a stylus pen for a personal digital mobile device. Said stylus pen is characterized by including a pen holder, a bolting joint, a pad, a nib, a nib cap and a touch needle. Said bolting joint is fixed in one end of a penholder. The nib having a ball at its tip and the pad are inserted in sequence into the nib cap. The touch needle is screwed to the rear end of the nib cap and then nip cap is screwed to the bolting joint. As a result, the pad presses against the ball of the nib for the nib protruding from the nib cap to bend or rotate as desired when a certain pressure is applied to it. It serves a buffer to any excessive force applied onto a PDA monitor or a touch monitor of PDA-related electronic product. The pen with its nib angle adjustable allows its user to go data input or option selection according to a way of holding a pen said user gets used to. In addition, the needle may be used as a substitute to press those built-in keys in the rear of the PDA.

Another purpose of the present invention is to provide a stylus pen for personal digital mobile device. Wherein, a ball pen refill may be placed into the hollow penholder and extending to the upper end of the penholder where a nib is fixed to hold the refill in position. An retractable pen cap is inserted to the outer circumference of the nib so that the PDA stylus pen also functions as a ball pen and the retractable nib cap may be pulled out to retreat the refill to protect the tip of the refill.

Another purpose yet of the present invention is to provide a stylus pen for a personal digital mobile device. Wherein, a snap pen cover is added to the retractable pen cap so that while using the ball pen refill, the snap pen cover is mounted on the nib cap at the other end to protect the nib of the stylus pen.

### BRIEF DESCRIPTION OF THE DRAWINGS

FIG. 1 is a schematic view of a stylus pen of the present invention applied on a PDA.

FIG. 2 is an exploded view showing members of the stylus pen of the present invention.

FIG. 3 is a sectional view showing the stylus pen of the present invention as assembled.

FIG. 4 is a schematic view showing a movement of the stylus pen of the present invention.

FIG. 5 is a schematic view showing the stylus pen of the present invention in use.

FIG. 6 is a sectional view showing a second preferred embodiment of the present as assembled.

FIG. 7 is a schematic view showing a movement of the second preferred embodiment of the present invention.

### DETAILED DESCRIPTION OF THE PREFERRED EMBODIMENTS

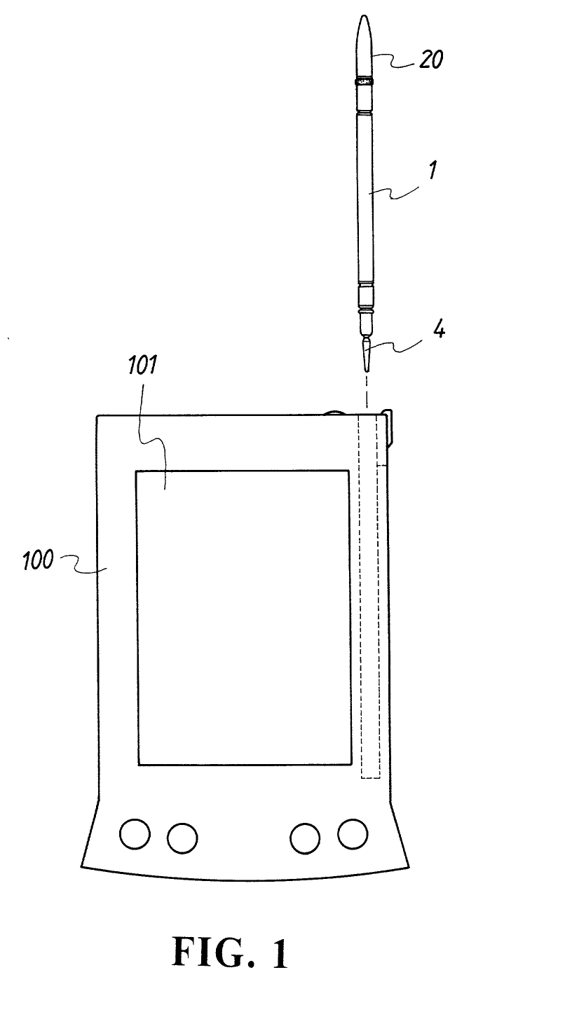

Referring to FIGS. 1, 2 and 3, a stylus pen of the present invention for a personal digital mobile device, namely, a PDA or any PDA(Personal Digital Assistant) related electronic product that provides a touch monitor, for data input or option selection is essentially comprised of a penholder 1, a bolting joint 2, a pad 3, a nib 4, a nib cap 5 and a touch needle 6. Within:

Said penholder 1 is a hollow cylinder;

Said bolting joint 2 is a section of solid cylinder having at its rear end provided with a section of post 21 in diameter compromising to the inner diameter of the penholder 1, and at it front end a bolt 22 having a recess 23 at its center;

Said pad is a cylindrical pad made of rubber, plastic or Teflon;

Said nib 4 is a section of metal rod having at its front end a conical nib and at its rear end a ball 41;

Said nib cap 5 is a hollow round cylinder having a flange 51 to the outer peripheral at its rear end and a section of threaded hole 52 on the inner wall in the rear end; and

Said touch needle 6 includes a threaded rod 61 and a tip 62 provided at the rear end of the bolt 61.

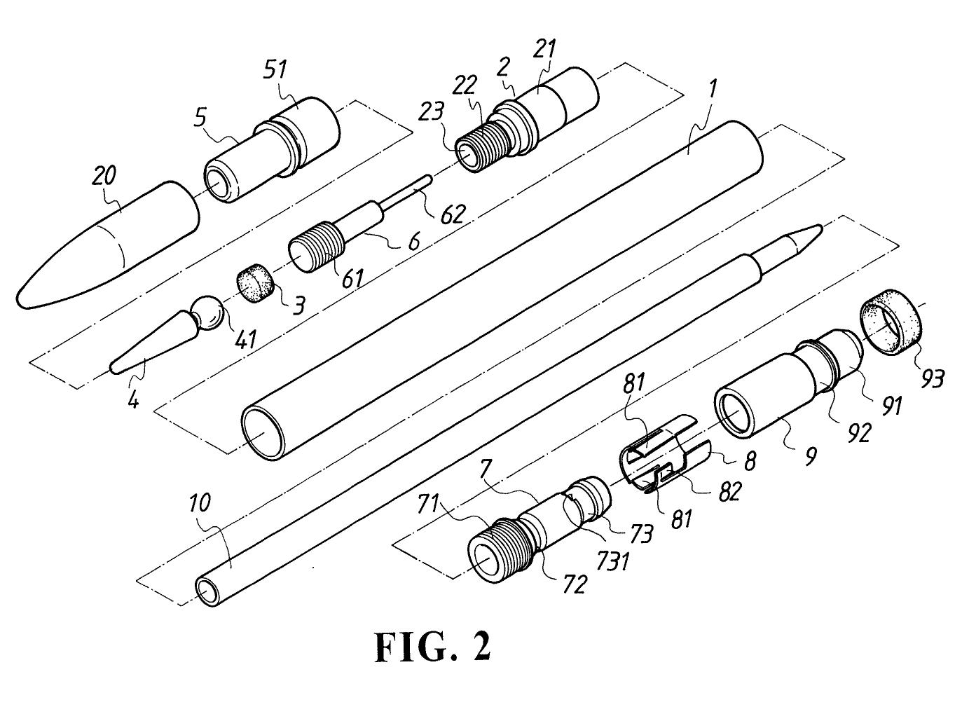

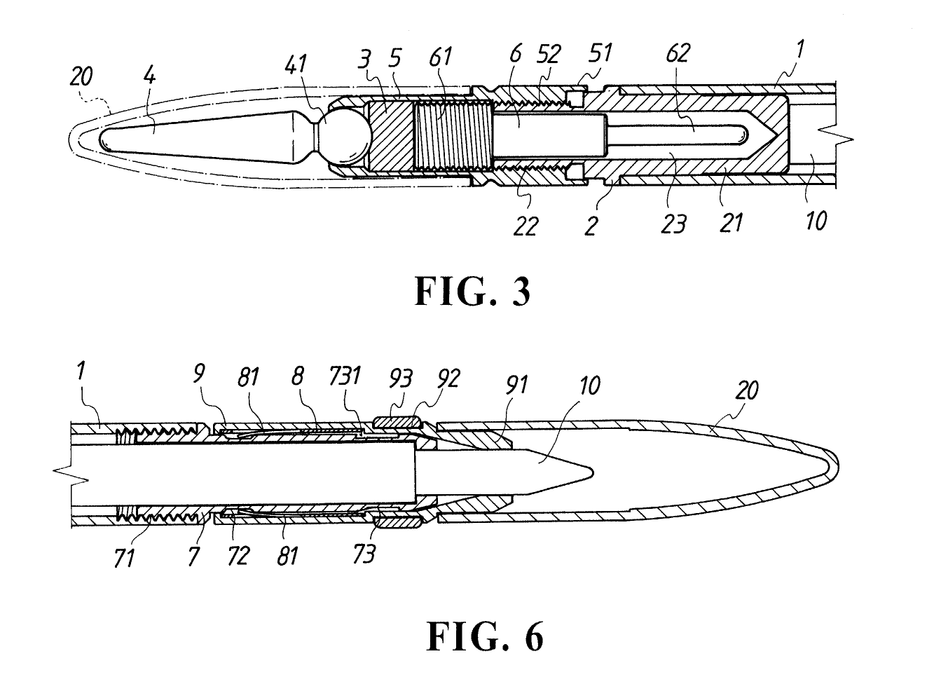

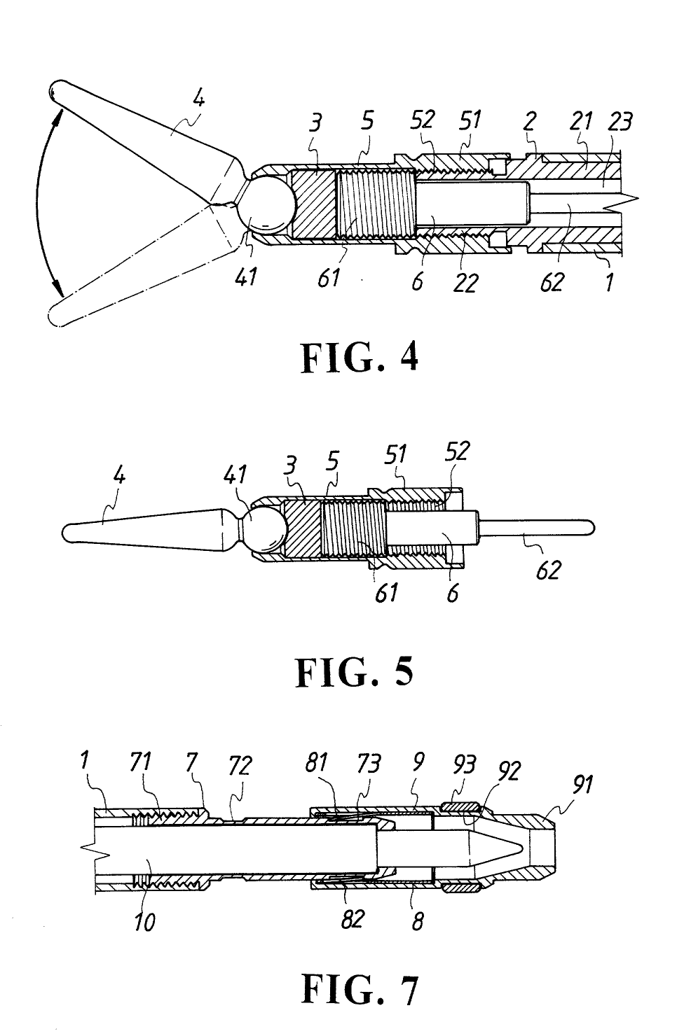

As illustrated in FIGS. 2 and 3, the post 21 at the rear end of the bolting joint 2 is inserted into the front of the penholder 1 to secure the bolting joint 2 to the penholder 1. Said nib 4 and said pad 3 are loaded into the nib cap 5 in sequence to permit the front end of the nib 4 merely penetrating through the nib cap 5 with said ball 41 being restricted inside the nib cap 5 to allow the nib 4 swing or rotate at any angle as desired. The threaded rod 61 of the touch needle 6 is inserted into the threaded hole 52 in the rear end of the nib cap 5 so that the tip 62 of the touch needle 6 extends to hold against the rear end of the nib cover 5. Meanwhile, said threaded rod 61 presses against the pad 3 and the ball 41 so that the nib 4 may bend or rotate at an angle as desired only when it is subject to a certain pressure. Then the rear end of the nib cap 5 is screwed to the front end of the bolting joint 2 so that said nib 4 and other members are incorporated at the front end of the penholder 1 to form a structure that requires a certain pressure for the nib 4 to bend to adjust the touching angle of the nib 4 as illustrated in FIG. 4.

By taking advantage of the present invention that the nib 4 bends to change its angle under a certain pressure, if a force to contact the PDA touch monitor by the nib 4 is excessive, the nib 4 bends upward to offset the excessive pressure, thus to protect the touch monitor from being damaged. As the touching angle of the nib 4 of the present invention is adjustable as desired, its user may preset the angle of the nib 4 to where he/she feels most comfortable when he/she is standing or lying down to use his/her PDA. As illustrated in FIG. 5, the touch needle 6 screwed to the rear end of the nib cap 5 may be used by retreating the nib cap 5 to expose the touch needle 6 to press any built-in key in the rear of the PDA (i.e. those keys provided in recess for fool-proof).

Of course, the other end of the present invention may be used to provide a ball pen, a fountain pen, a pencil, a marker, or a steel ball pen. In a preferred embodiment of the present invention as illustrated in FIGS. 2 and 6, an application of a ball pen is disclosed including a refill 10, a nib 7, a restriction ring 8 and a retractable nib cover 9. Within:

Said ball pen refill relates to one that is generally available in the market;

Said nib 7 is a hollow cylinder with an external section of threaded rod 71 provided to its read end, circular grooves 72, 73 respectively at its mid and front end, and one or more than one indent 731 extending from its rear end at the rear edge of the front groove 73;

Said restriction ring 8 is a metal ring with its wall punched with one or more than one tab 81 inclining inwardly and backward, and one or more than one tab 82 inclining inwardly and forward; and

Said retractable nib cap 9 is a hollow cylinder having at its front end provided with a conic head 91 in a diameter slightly smaller than that of the nib cap 9, and a ring 93 is inserted in a groove 92 provided at the outer circumference of the retractable nib cap 9.

As illustrated in FIGS. 2 and 6, said ball pen refill 10 is inserted into the penholder 1 and the nib 7 is screwed to the upper end of the penholder 1 in a way that the nib 7 is merely covering up and holding the ball pen refill 6 to prevent it from escaping. The restriction ring 8 is inserted between said both grooves 72 and 73 in the nib 7 with the tab 81 caught in the groove 72. With the nib 7 inserted into the retractable pen cover 9 for the restriction ring 8 to be also accommodated by the retractable pen cover 9, the retractable nib cover 9 is only permitted to extend or retract without being disengaged. As a result, the stylus pen of the present invention also serves as a traditional writing pen. When the ball pen refill 10 is not used, the retractable pen cover 9 is pulled out to cover up the tip of the refill 10 as illustrated in FIG. 7 for the tab 82 to hold against the front wall edge of the groove 73 and the tab 81 is caught in the indention 731 of the front groove 73 to prevent the retractable pen cover 9 from accidental retraction or disengagement for protecting the tip of the refill 10. If the refill 10 is to be used, turn the retractable pen cover 9 to allow the tab 82 disengage from the indention 731 to push in the retractable pen cover 9 as guided by the slanted wall in the groove 73 to expose the refill 10.

Furthermore, as illustrated in FIGS. 2, 3 and 6, a conic hollow snap pen cover 20 may be added to the present invention to protect the nib 4 provided at the front end of the nib cap 5 while mounting the snap pen cover 10 on the other end of the retractable pen cover 9 to protect the refill 10. That is, the snap pen cover 10 protects either end of the stylus pen that is not used. It is to be noted that the presentation of the art of the present invention is related to the nib 4 with its touching angle changeable as desired. Any and all preferred embodiments might be provided as options.

1. A personal digital mobile device stylus pen adapted to a touch monitor comprised of a penholder, a pad, a nib, a nib cap and a touch needle, characterized by that said penholder in the shape of a cylinder, said pad relating to a cylindrical pad made of rubber material; said nib indicating a metal rod having at its front end a conic tip and a ball at the selected rear end; said nib cap relating to a hollow cylinder; and said touch needle having a threaded bolt and a tip at its rear end; said nib and pad inserted in sequence into said nib cap with the nib penetrating through the nib cap and the ball at rear end restricted in the nib cap; the touch needled screwed into threaded rear end of the nib cap with the threaded bolt allowing the needle extending towards the rear end of the nib cap; thus for the nib to bend or rotate at any angle desired when being subject to a certain pressure while the bolt pressing against both said pad and ball to prevent a monitor from being damaged under excessive force from the stylus pen and to allow comfortable operation of the stylus pen with a touch angle that suits best its user.

2. A personal digital mobile device stylus pen as claimed in claim 1, wherein, a bolting joint is inserted to the front end of the penholder and a threaded rod provided in the front of the bolting joint to receive the nib and to accommodate an assembly of the nib and other members at the front end of the penholder.

3. A personal digital mobile device stylus pen as claimed in claim 1, wherein, a traditional writing tool is provided to the upper end of the stylus pen.

4. A personal digital mobile device stylus pen as claimed in claim 3, wherein, said traditional writing tool relates to a ball pen including a ball pen refill, a hollow cylindrical nib and a restriction ring and a retractable pen cover; said ball pen refill relating to one that is generally available in the market; the nib, a hollow cylinder having external to its rear end a threaded rod, a groove each respectively at its mid and its front outer circumference, and one or more than one indention extending backward at the rear edge of the front groove; said restriction ring, in hollow tubular shape having at its wall one or more than one tab extending backward and inwardly at an inclination and one or more than one tab extending forwardly and inwardly at an inclination; and said retractable pen cover relating to a hollow cylinder characterized by that said refill inserted into the upper end of the penholder having the nib screwed to the upper end of the penholder; said restriction ring inserted between said two grooves in the nib; said tab extending backward caught in the groove; the nib inserted into the retractable pen cover for it to retreat or extend without being disengaged.

5. A personal digital mobile device stylus pen as claimed in claim 1, wherein, a conic hollow snap pen cover is provided at the front end of the nib to protect the nib.
